(19) United States
(12) Patent Application Publication
(10) Pub. No.: US 2018/0239217 A1
(43) Pub. Date: Aug. 23, 2018

(54) LENS DRIVE DEVICE, CAMERA MODULE, AND CAMERA MOUNT DEVICE

(71) Applicants: Shinsuke KONUMA, Tokyo (JP); Toshihiro HIKICHI, Tokyo (JP); Satoshi AJIKI, Tokyo (JP)

(72) Inventors: Shinsuke KONUMA, Tokyo (JP); Toshihiro HIKICHI, Tokyo (JP); Satoshi AJIKI, Tokyo (JP)

(73) Assignee: MITSUMI ELECTRIC CO., LTD., Tokyo (JP)

(21) Appl. No.: 15/756,089

(22) PCT Filed: Aug. 30, 2016
(86) PCT No.: PCT/JP2016/075266

§ 371 Date: Feb. 28, 2018

(30) Foreign Application Priority Data
Aug. 31, 2015 (JP) 2015-170921

(51) Int. Cl. G03B 5/00; G02B 7/04; G02B 27/64; G03B 13/36

(52) U.S. Cl. CPC G03B 5/00; G02B 7/04; G03B 2205/0015; G03B 13/36; G03B 2205/0069; G02B 27/646

(57) ABSTRACT

A lens drive device is provided with a shake-correction drive unit for correcting shake by sliding, in relation to a shake-correction fixed part including a shake correction coil part, a shake-correction movable part including a magnet part and a magnet holder, within a plane intersecting with an optical axis direction, using the drive force of a voice coil motor composed of the magnet part, which is held by the magnet holder, and the shake-correction coil part. The shake-correction movable part has a yoke that engages with the magnet holder, and is disposed on the surface side of the magnet part in a direction intersecting with the optical axis direction, the surface of the yoke on the shake-correction coil part side being flush with the surface of the magnet part on the shake-correction coil side.

### TECHNICAL FIELD

The present invention relates to an auto-focusing and shake-correcting lens driving device, a camera module having an auto-focusing function and a shake-correcting function, and a camera mounting device.

### BACKGROUND ART

In general, a small-sized camera module is mounted in a mobile terminal such as a smartphone. In such a camera module, a lens driving device is employed (for example, PTLS 1 and 2). In such a camera module, a lens driving device is employed (for example, PTLS 1 and 2). The lens driving device has an auto-focusing function of automatically performing focusing for capturing a subject (hereinafter referred to as “AF (Auto Focus) function”), and a shake-correcting function (hereinafter referred to as “OIS (Optical Image Stabilization) function”) of optically correcting shake (vibration) upon capturing an image to reduce the irregularities of the image.

The auto-focusing and shake-correcting lens driving device includes an auto-focusing driving part (hereinafter referred to as “AF driving part”) for moving the lens part in the light axis direction, and a shake-correcting driving part (hereinafter referred to as “OIS driving part”) for swaying the lens part in a plane orthogonal to the light axis direction.

The AF driving part includes, for example, an auto-focusing coil part (hereinafter referred to as “AF coil part”) disposed around the lens part, and an auto-focusing magnet part (hereinafter referred to as “AF magnet part”) disposed separately from the AF coil part in the radial direction. An auto-focusing movable part (hereinafter referred to as “AF movable part”) including the lens part and the AF coil part is moved with respect to an auto-focusing fixing part (hereinafter referred to as “AF fixing part”) including the AF magnet part in the light axis direction by use of a driving force of a voice coil motor composed of the AF coil part and the AF magnet part, and thus focusing is automatically performed.

The OIS driving part includes a shake-correcting magnet part (hereinafter referred to as “OIS magnet part”) disposed at the AF driving part, and a shake-correcting coil part (hereinafter referred to as “OIS coil part”) disposed separately from the OIS magnet part in the light axis direction, for example. A shake-correcting movable part (hereinafter referred to as “OIS movable part”) including the AF driving part and the OIS magnet part is supported by a supporting member so as to be separated from a shake-correcting fixing part (hereinafter referred to as “OIS fixing part”) including the OIS coil part in the light axis direction. The OIS movable part is swayed in a plane orthogonal to the light axis direction by use of a driving force of a voice coil motor composed of the OIS magnet part and the OIS coil part, and thus shake correction is performed.

FIG. 1 illustrates a magnetic circuit that drives a lens part in a conventional lens driving device. In the lens driving device of PTL 1 illustrated in FIG. 1, an OIS magnet part is used also as an AF magnet part. To be more specific, AF movable part 5 where a lens part (omitted in the drawing) is disposed includes lens holder 51 and AF coil part 52, and AF fixing part 6 includes magnet holder 61 and magnet part 62 (which is the AF magnet part used also as the OIS magnet part).

In addition, OIS movable part 7 includes an AF driving part (AF movable part 71 and AF fixing part 72). OIS movable part 7 is supported in a state where OIS movable part 7 is separated from OIS coil part 8 of an OIS fixing part (omitted in the drawing) on the light reception side in the light axis direction. It is to be noted that an image pickup part includes an image pickup device (omitted in the drawing) such as a CCD (Charge Coupled Device) image sensor, and is disposed on the imaging side of the lens part in the light axis direction. An image pickup device (omitted in the drawing) captures a subject image that is brought into an image by the lens part (not illustrated), and an IR filter (omitted in the drawing) is disposed on the light reception side of the image pickup device (omitted in the drawing) in the light axis direction.

### CITATION LIST

### Patent Literature

PTL 1
WO2013/121788
PTL 2
Japanese Patent Application Laid-Open No. 2014-85624

### SUMMARY OF INVENTION

### Technical Problem

Incidentally, in the lens driving device disclosed in PTL 1, AF movable part 5 obtains focus by moving to the imaging side or the light reception side in the light axis direction with respect to magnet part 62 magnetized opposite to AF coil part 52, or in other words, by moving toward or away from the image pickup part in FIG. 1. In addition, OIS movable part 7 sways in a plane orthogonal to the light axis direction with a leakage magnetic flux of magnet part 62 with respect to OIS coil part 8 disposed below magnet part 62 magnetized opposite to AF coil part 52.

As described above, the lens driving device disclosed in PTL 1 uses magnet part 62 as the AF magnet part and the OIS magnet part, and thus does not require two separate magnets of the two functions, thereby achieving downsizing of the lens driving device. This structure of the lens driving device uses the leakage magnetic flux J of magnet part 62 disposed to ensure the magnetic flux for AF, and consequently it is difficult to obtain a sufficient thrust in a sway direction in a plane orthogonal to the light axis direction for moving the OIS movable part 7.

Here, it is conceivable to use a yoke to collect the magnetic flux of magnet part 62 as disclosed in PTL 2. However, in the configuration disclosed in PTL 2, the height of the yoke attached to the magnet part is higher than the height of the magnet part and a magnetism gap thinner than the magnet part is configured on the upper side of the magnet part so as to collect the magnetic flux to the AF coil. Consequently, the magnetic flux for increasing the thrust (thrust for the OIS) in a sway direction in a plane orthogonal to the light axis direction might be reduced, and might not be sufficiently ensured.

An object of the present invention is to provide a lens driving device that can favorably ensure a thrust for the OIS while achieving downsizing, and a camera module and a camera mounting apparatus including the lens driving device.

### Solution to Problem

A lens driving device according to the embodiment of the present invention includes a shake-correcting driving part. The shake-correcting driving part includes a magnet part that is disposed at a periphery of a lens part, a magnet holder that holds the magnet part, and a shake-correcting coil part that is disposed in such a manner that the shake-correcting coil part is separated from the magnet part in a light axis direction; the shake-correcting driving part performs shake correction by swaying, in a plane orthogonal to the light axis direction, a shake correction movable part including the magnet part and the magnet holder with respect to a shake correction fixing part including the shake-correcting coil part by using a driving force of a voice coil motor including the magnet part and the shake-correcting coil part; the shake correction movable part includes a yoke, the yoke being configured to be engaged with the magnet holder and disposed on a side of one surface of the magnet part, the one surface being one of surfaces of the magnet part spacing away from each other in a direction orthogonal to the light axis direction; and a surface of the yoke on the shake-correcting coil part side is flush with a surface of the magnet part on the shake-correcting coil part side.

A camera module according to the embodiment of the present invention includes: the above-mentioned lens driving device; a lens part that is mounted to the auto focus movable part; and an image pickup part that captures a subject image imaged by the lens part.

A camera mounting apparatus according to the embodiment of the present invention includes is an information apparatus or a transport apparatus, the camera mounting apparatus comprising the above-mentioned camera module.

### Advantageous Effects of Invention

According to the present invention, it is possible to favorably ensure a thrust for the OIS while achieving downsizing.

### BRIEF DESCRIPTION OF DRAWINGS

FIG. 1 illustrates displacement of a lens part in a conventional lens driving device;

FIGS. 2A and 2B illustrate a smartphone in which a camera module according to an embodiment of the present invention is mounted;

FIG. 3 is a perspective view illustrating an external appearance of the camera module;

FIG. 4 is an exploded perspective view of the camera module;

FIG. 5 is an exploded perspective view of a lens driving device;

FIG. 6 is an exploded perspective view of an OIS movable part;

FIG. 7 is an exploded perspective view of an OIS fixing part;

FIG. 8 is a sectional view of the camera module taken along directions of a Z axis and an X axis;

FIG. 9 is a sectional view of the camera module taken along directions of the Z axis and a Y axis;

FIG. 10 is a side view of the lens driving device, which illustrates a relationship between a yoke and a magnet part;

FIGS. 11A and 11B schematically illustrate a modification of the yoke;

FIGS. 12A and 12B schematically illustrate a modification of the yoke; and

FIGS. 13A and 13B illustrate an automobile serving as a camera mounting device in which an in-vehicle camera module is mounted.

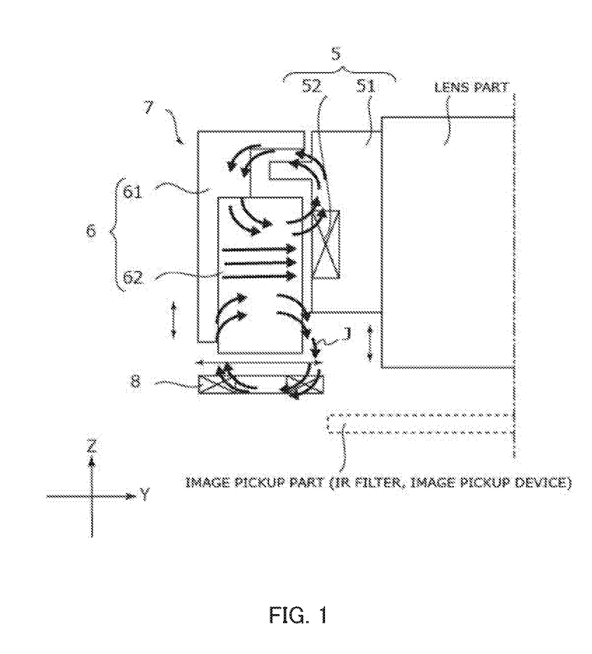

### DESCRIPTION OF EMBODIMENTS

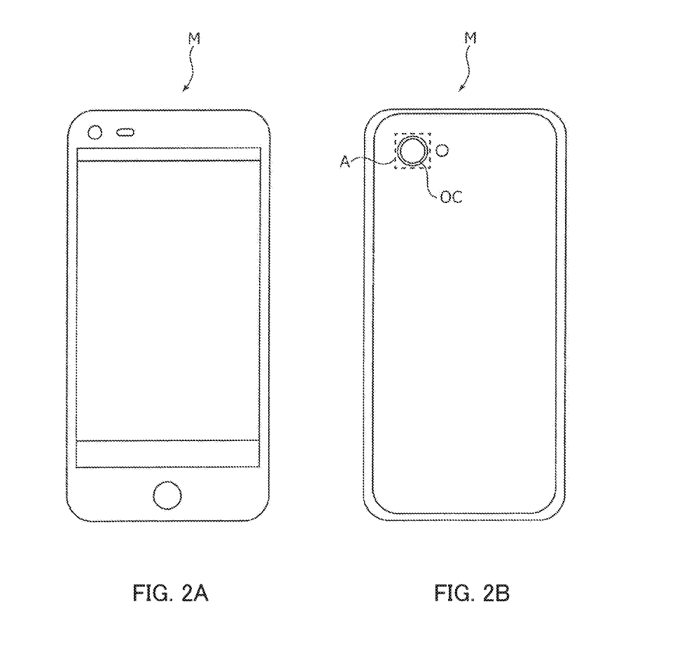

In the following, an embodiment of the present invention is described in detail with reference to the drawings. FIGS. 2A and 2B illustrate smartphone M in which camera module A according to the embodiment of the present invention is mounted. FIG. 2A is a front view of smartphone M, and FIG. 2B is a rear view of smartphone M.

For example, smartphone M is provided with camera module A as a back side camera OC. Camera module A has an auto-focusing function and a shake-correcting function, and can capture an image without image blurring by automatically performing focusing at the time of capturing a subject, and by optically correcting shake (vibration) at the time of capturing an image.

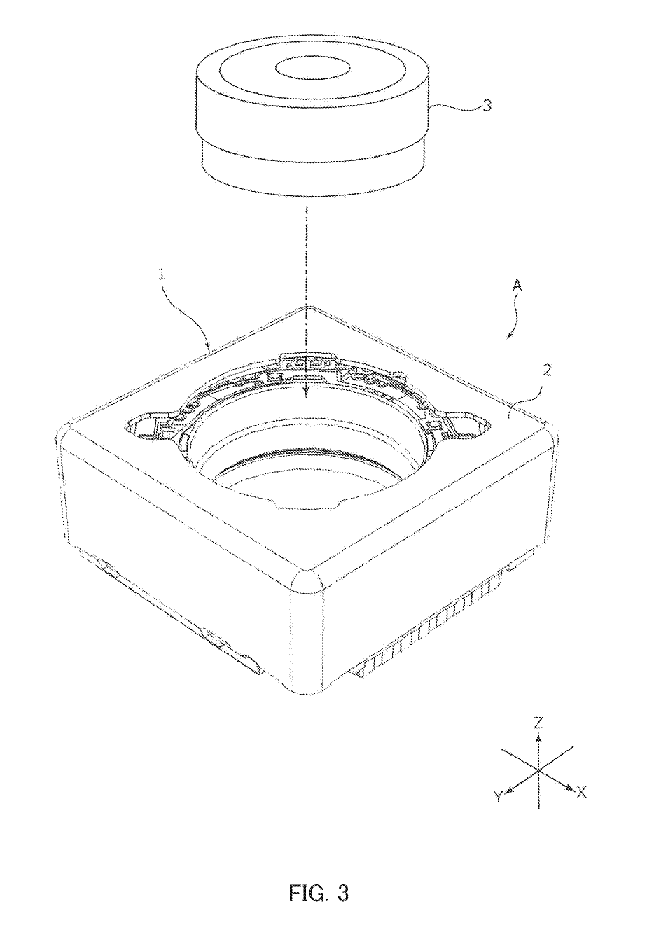

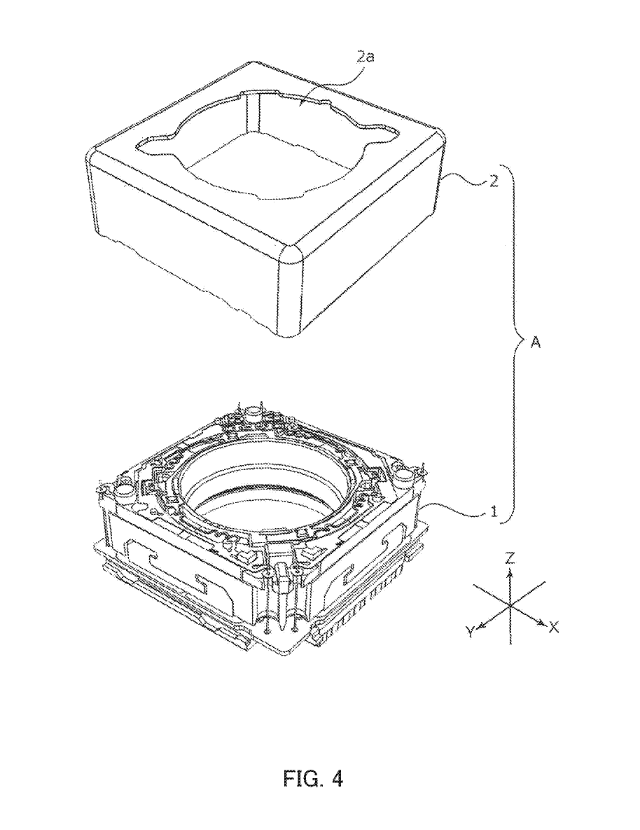

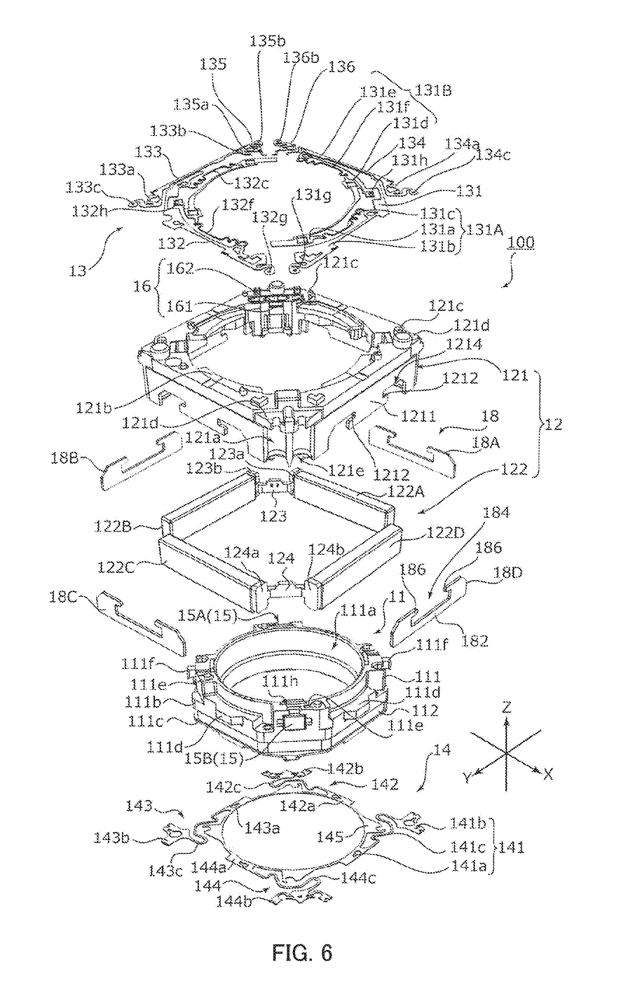

FIG. 3 is a perspective view of an external appearance of camera module A. FIG. 4 is an exploded perspective view of camera module A. As illustrated in FIG. 3 and FIG. 4, descriptions will be made with an orthogonal coordinate system (X, Y, Z) in the present embodiment. Also in the drawings described later, descriptions will be made with an orthogonal coordinate system (X, Y, Z). Camera module A is mounted such that the vertical direction (or horizontal direction) is the X direction, the horizontal direction (or vertical direction) is the Y direction, and the front-rear direction is the Z direction at the time of actually capturing an image with smartphone M. That is, the Z direction is the light axis direction, the upper side in the drawing is the light reception side in the light axis direction (also referred to as “macro position side”), and the lower side is the imaging side in the light axis direction (also referred to as “infinity position side”). Here, the “macro position” means a lens position (the position on the most light reception side) for bringing a subject located at a shortest imaging distance into focus, and the “infinity position” means a lens position (the position on the most imaging side) for bringing a subject located at the infinity into focus. That is, the range from the macro position to the infinity position is the movable range of AF movable part 11 (see FIG. 6).

Camera module A includes lens part 3 in which a lens is housed in a lens barrel having a cylindrical shape, AF and OIS lens driving device 1, an image capturing part (not illustrated) that captures a subject image imaged with the lens part, shield cover 2 that covers the entirety, and the like.

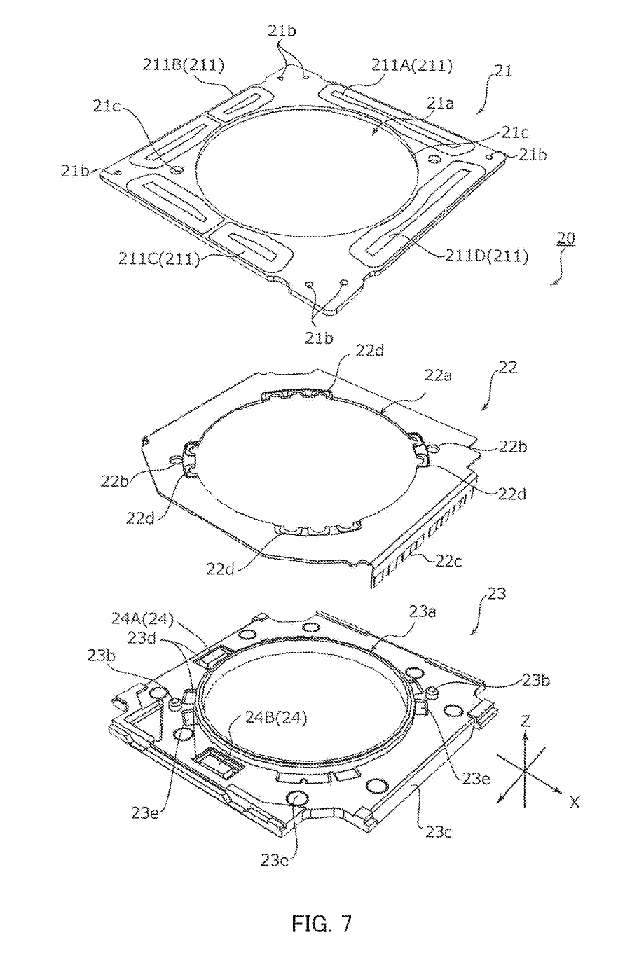

As viewed in the light axis direction, shield cover 2 is a capped square cylindrical body having a square shape in plan view. Circular opening 2a is formed in the top surface of shield cover 2. A lens part (not illustrated) is exposed to the outside through opening 2a . Shield cover 2 is fixed to base member 23 (see FIG. 7) of OIS fixing part 20 of lens driving device 1. Shield cover 2 has conductivity, and electrically connected with a ground terminal (not illustrated) of OIS fixing part 20, and is grounded.

The image capturing part (not illustrated) includes an image pickup device (not illustrated), and is disposed on the imaging side in the light axis direction of the lens driving device 1. The image pickup device (not illustrated) is composed of, for example, a CCD (charge coupled device) image sensor, a CMOS (complementary metal oxide semiconductor) image sensor, or the like. The image pickup device (not illustrated) captures a subject image imaged by a lens part (not illustrated). An IR filter (not illustrated) is disposed on the light reception side in the light axis direction of image pickup device (not illustrated).

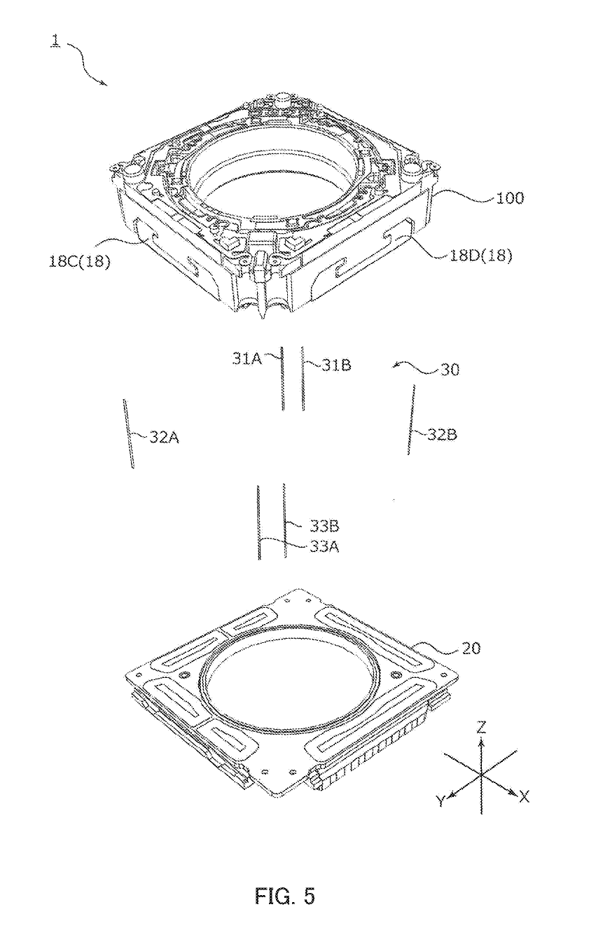

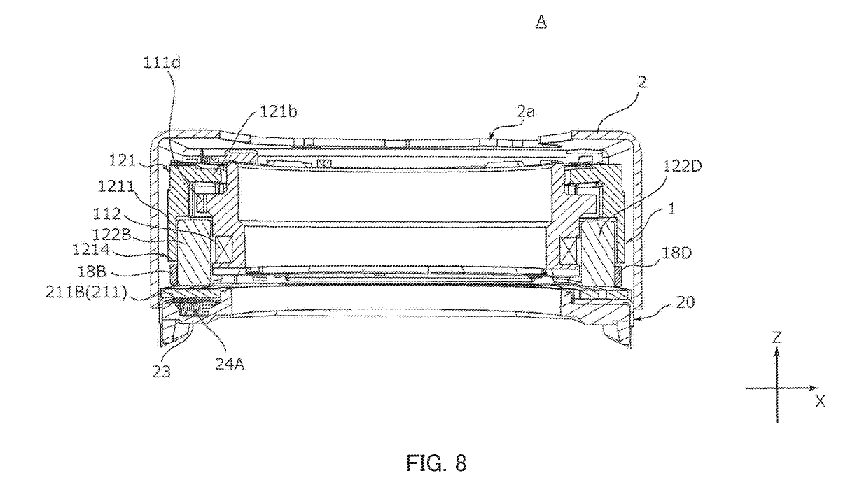

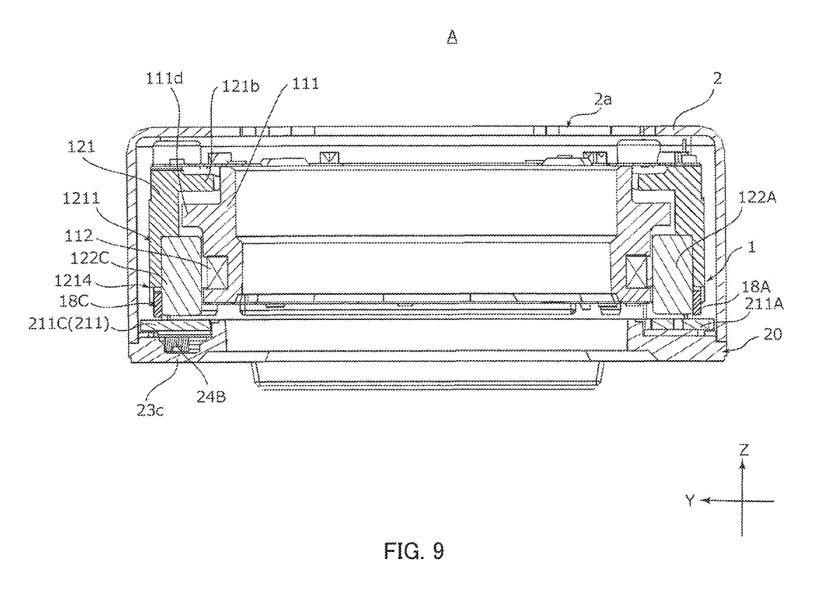

FIG. 5 is an exploded perspective view of lens driving device 1, and FIG. 6 is an exploded perspective view of OIS movable part 100. In addition, FIG. 7 is an exploded perspective view of OIS fixing part 20, FIG. 8 is a sectional view of camera module A illustrated in FIG. 2 taken along the directions of the Z axis and the X axis, and FIG. 9 is a sectional view of camera module A illustrated in FIG. 2 taken along the directions of the Z axis and the Y axis. As illustrated in FIG. 5, lens driving device 1 includes OIS movable part (shake correction movable part) 100, OIS fixing part 20, supporting member 30, and the like.

OIS movable part 100 includes an OIS magnet part (here, magnet part 122) serving as a component of the OIS voice coil motor, and sways in the XY plane at the time of shake correction. OIS fixing part 20 includes an OIS coil part. That is, the OIS lens driving part of lens driving device 1 is of a moving magnet type. OIS movable part 100 includes an AF driving part (AF movable part 11 and AF fixing part 12, see FIG. 6).

OIS movable part 100 is disposed on the light reception side in the light axis direction relative to OIS fixing part 20 and is separated from OIS fixing part 20. OIS movable part 10 is coupled with OIS fixing part 20 by supporting member 30. To be more specific, supporting member 30 is composed of six suspension wires extending along the Z direction (hereinafter referred to as “suspension wire 30”). One end (upper end) of suspension wire 30 is fixed to OIS movable part 100 (upper elastic supporting part 13, see FIG. 6), and the other end (lower end) of suspension wire 30 is fixed to OIS fixing part 20 (coil substrate 21, see FIG. 7). OIS movable part 100 is supported by suspension wire 30 such that OIS movable part 10 can sway in the XY plane.

In the present embodiment, suspension wires 31A and 31B among six suspension wires 30 are used as signal paths of Hall device 161 (see FIG. 6) (signaling suspension wires). In addition, suspension wires 32A and 32B are used as power feeding paths to Hall device 161 (feeding suspension wires for Hall device). Further, suspension wires 32A and 32B are used as power feeding paths to AF coil part 112 (feeding suspension wires for coil). It is to be noted that the number of suspension wires 30 are not limited, and seven or more suspension wires 30 may be provided.

As illustrated in FIG. 6, OIS movable part 100 includes AF movable part 11, AF fixing part 12, upper elastic supporting part 13, lower elastic supporting part 14 and the like. AF movable part 11 includes an AF coil part serving as a component of an AF voice coil motor, and moves in the light axis direction at the time of focusing. AF fixing part 12 is a part having an AF magnet part. That is, the AF driving part of lens driving device 1 is of a moving coil type. AF movable part 11 is disposed on the radially inside relative to AF fixing part 12 and is separated from AF fixing part 12. AF movable part 11 is coupled with AF fixing part 12 by upper elastic supporting part 13 and lower elastic supporting part 14.

AF movable part 11 includes lens holder 111, AF coil part 112, and position detection magnet 15.

Lens holder 111 is a member having a cylindrical shape, and a lens part (not illustrated) is fixed to lens housing part 111a by bonding or screwing. Lens holder 111 includes upper flange part 111b and lower flange part 111c on the peripheral surface of lens housing part 111a. AF coil part 112 is wound at a part (hereinafter referred to as “coil winding part”) sandwiched between upper flange part 111b and lower flange part 111c.

Lens holder 111 includes upper spring fixing parts 111e that fix upper elastic supporting part 13 at four portions that intersect the directions of 45° (hereinafter referred to as “diagonal direction”) with respect to the X direction and the Y direction (hereinafter referred to as “cross direction”) at an upper portion of the outer periphery of lens housing part 111a. Lens holder 111 includes tying parts 111f that radially outwardly protrude from two diagonally-opposite upper spring fixing parts 111e of four upper spring fixing parts 111e. In addition, lens holder 111 includes, at four portions that intersect the cross direction at the bottom surface, a lower spring fixing part that fix lower elastic supporting part 14 (omitted in the drawing).

Lens holder 111 includes, at four portions that intersect the cross direction at an upper portion of the outer periphery of lens housing part 111a, protruding parts 111d that radially outwardly overhang over upper flange part 111b and lower flange part 111c. The top surfaces of protruding parts 111d serve as locking parts for restricting the movement of AF movable part 11 to the light reception side in the light axis direction, and the bottom surfaces of protruding parts 111d serve as locking parts for restricting the movement of AF movable part 11 to the imaging side in the light axis direction.

AF coil part 112 is an air-core coil that is energized at the time of focusing, and is wound around the outer peripheral surface of a coil winding part of lens holder 111. The both ends of AF coil part 112 are tied to tying parts 111f of lens holder 111.

Position detection magnet 15 is disposed at magnet housing part 111h formed at upper spring fixing part 111e of lens holder 111. Detection magnet 15 that is disposed at a position on the side corresponding to position detection part 16 (hereinafter referred to as “first position detection magnet 15A”) is practically used for position detection of AF movable part 11. The other position detection magnet 15 (hereinafter referred to as “second position detection magnet 15B”) is a dummy magnet that is not used for the position detection of AF movable part 11. Second position detection magnet 15B is disposed for balancing a magnetic force which acts on AF movable part 11 and stabilizing the orientation of AF movable part 11. Specifically, when second position detection magnet 15B is not disposed, a one-sided magnetic force is exerted on AF movable part 11 due to the magnetic field generated at magnet part 122, and the orientation of AF movable part 11 becomes unstable, and therefore, second position detection magnet 15B is disposed to prevent such a situation.

AF fixing part 12 includes magnet holder 121, magnet part 122, and position detection part 16. Magnet part 122 is attached after AF movable part 11 is inserted to magnet holder 121.

Magnet holder 121 has a quadrangular cylindrical shape which is square in plan view. Here, magnet holder 121 is formed with a non-magnetic substance, and holds magnet part 122 that is attached to the inner surface of side wall 1211. Side wall 1211 includes engagement portion 1214 that is engaged with engaging portion 184 of yoke 18 (18A to 18D). Engagement portion 1214 has a cutout shape that opens downward at a lower portion of side wall 1211, and is engaged with yoke 18 (18A to 18D) in the X axis direction or the Y axis direction so as to restrict the movement in the Z direction.

In magnet holder 121, suspension wire 30 is disposed at a portion (hereinafter referred to as “wire insertion part 121a”) that is recessed radially inward in an arc-shape at four coupling portions of the side walls (four sides along Z direction). With wire insertion part 121a, interference between suspension wire 30 and magnet holder 121 at the time when OIS movable part 100 sways is avoided.

Magnet holder 121 includes, at the upper portion, stopper parts 121b that protrude inward in the radial direction in a ring-shape. In stopper part 121b, the portion corresponding to upper spring fixing part 111e of lens holder 111 is cut out such that AF movable part 11 can move to the light reception side in the light axis direction relative to the top surface of magnet holder 121. When AF movable part 11 moves to the light reception side in the light axis direction, stopper part 121b makes contact with protruding parts 111d of lens holder 111, and thus the movement of AF movable part 11 to the light reception side in the light axis direction is restricted. In addition, arm parts 131c, 131f, 132c and 132f of upper elastic supporting part 13 are placed on the top surface of stopper part 121b.

Magnet holder 121 includes, at the four corners of bottom surface 121e, lower spring fixing parts (hereinafter referred to as “lower spring fixing parts 121e”) that fix lower elastic supporting part 14. Magnet holder 121 includes, at the four corners of the upper portion, upper spring fixing parts 121c that fix upper elastic supporting part 13. The top surface of corner 121d of upper spring fixing part 121c (hereinafter referred to as “damper installation part 121d”) is slightly recessed from the top surface (the surface on which upper elastic supporting part 13 is attached) of magnet holder 121 such that a gap is formed when upper elastic supporting part 13 is attached. A vertex part (the portion provided continuously with the upper portion of wire insertion part 121a) of damper installation part 121d protrudes outward relative to the lower portion, and is cut out in an arc-like shape. The cut-out portion having an arc-like shape of damper installation part 121d forms a part of wire insertion part 121a.

Magnet part 122 includes four cuboid permanent magnets 122A to 122D and coupling yoke 123. Permanent magnets 122A to 122D are disposed along the inner surfaces of the four side walls of magnet holder 121. As illustrated in FIG. 8 and FIG. 9, permanent magnets 122A to 122D are magnetized such that a traversing magnetic field in the radial direction is formed at AF coil part 112. For example, permanent magnets 122A to 122D are magnetized such that the inner periphery side and the outer periphery side thereof are set to N pole and S pole, respectively. Protruding part 111d of lens holder 111 is located in a space between magnet part 122 and stopper part 121b of magnet holder 121.

The AF voice coil motor is composed of magnet part 122 and AF coil part 112. In the present embodiment, magnet part 122 serves as the AF magnet part and as the OIS magnet part.

One of end surfaces of permanent magnet 122A in the longitudinal direction, and an end surface of adjacent permanent magnet 122B in the longitudinal direction are coupled with each other with coupling yoke 123. Coupling yoke 123 includes yoke part 123a at one end portion thereof, and yoke part 123b at the other end portion thereof. Specifically, yoke part 123a is disposed at an end surface of permanent magnet 122A in proximity to first position detection magnet 15A, and yoke part 123b is disposed at an end surface of permanent magnet 122B in proximity to first position detection magnet 15A.

Likewise, one of end surfaces of permanent magnet 122C in the longitudinal direction, and an end surface of adjacent permanent magnet 122D in the longitudinal direction are coupled with each other with coupling yoke 124. Yoke part 124a is disposed at an end surface of permanent magnet 122C in proximity to second position detection magnet 15B, and yoke part 124b is disposed at an end surface of permanent magnet 122D in proximity to second position detection magnet 15B.

Yoke parts 123a and 123b are used for suppressing intersection of the magnetic flux generated at magnet part 122 and the detection part of Hall device 161, that is, for reducing a leakage flux. By disposing yoke parts 123a and 123b, it is possible to reduce the output offset of Hall device 161, and set amplification gain to a high level, and thus, the detection sensitivity is improved. When yoke parts 123a and 123b are disposed, an attraction is generated between first position detection magnet 15A and yoke parts 123a and 123b. Yoke parts 124a and 124b are disposed for balancing the magnetic force which acts on AF movable part 11, and for stabilizing the orientation of AF movable part 11.

While coupling yokes 123 and 124 are employed in the present embodiment, yoke parts 123a, 123b, 124a, and 124b may be independent members. It should be noted that, preferably, yoke parts 123a and 123b are coupled with each other as described in the present embodiment. With such a configuration, the ease of attaching operation is remarkably increased in comparison with the case where the yoke part is attached to each of permanent magnets 122A and 122B. In addition, an attraction is generated also between first position detection magnet 15A and the coupling part that couples yoke part 123a and yoke part 123b, and therefore, by designing coupling yoke 123 such that an attraction having a desired value is obtained, the thickness of yoke parts 123a and 123b can be reduced. Accordingly, the length of permanent magnets 122A and 122B can be increased, and therefore the driving performance of the AF driving part is improved. Furthermore, the above-mentioned configuration is useful for reinforcing the strength of AF fixing part 12.

Yoke 18 is formed with a magnetic substance, which is, for example, a plate-shaped magnetic substance such as a SPCC (cold-rolled steel sheet). Yoke 18 is connected to magnet part 122 to increase the attraction of magnet part 122. Here, yoke 18 includes four plate-shaped yokes 18A to 18D that are connected to permanent magnets 122A to 122D, respectively.

At magnet part 122, yokes 18A to 18D are disposed on the side of one surface of magnet part 122(permanent magnets 122A to 122D), the one surface being one of surfaces of magnet part 122(permanent magnets 122A to 122D) spacing away from each other in the direction orthogonal to the light axis direction. Here, yokes 18A to 18D are attracted and attached to permanent magnets 122A to 122D in the magnetization direction (here, outside in the magnetization direction). Yokes 18A to 18D are attached to respective permanent magnets 122A to 122D in such a manner that the bottom surfaces thereof (the surfaces on OIS coils 211A to 211D side) are flush with the bottom surfaces (the surfaces on OIS coils 211A to 211D side) of the respective permanent magnets 122A to 122D. That is, it is preferable that the bottom surfaces of yoke 18 (yokes 18A to 18D) and magnet part 122 (permanent magnets 122A to 122D), which are surfaces on OIS coil part 211 (OIS coils 211A to 211D) side in the light axis direction, be flush with each other. These flush bottom surfaces face OIS coil part 211 (OIS coils 211A to 211D). In addition, the top surfaces of yokes 18A to 18D have the same height as the top surfaces of respective permanent magnets 122A to 122D, or are lower than the top surfaces of respective permanent magnets 122A to 122D.

At an upper part of each of yokes 18A to 18D, engaging portion 184 for engagement with engagement portion 1214 of side wall 1211 of magnet holder 121 is formed. Engaging portion 184 is formed in a shape that matches the shape of engagement portion 1214, and when engaging portion 184 is in engagement with engagement portion 1214, the movement in one direction of the two directions orthogonal to each other in the horizontal direction (X axis direction or Y axis direction) is restricted. That is, with the engagement between engaging portion 184 and engagement portion 1214, yokes 18A to 18D can be precisely disposed at respective positioned locations in the horizontal direction with respect to permanent magnets 122A to 122D that are attached to magnet holder 121.

As illustrated in FIG. 6, in the present embodiment, each of the engaging portions 184 of yokes 18A to 18D is formed in a recessed shape, and each of engagement portions 1214 of side wall 1211 of magnet holder 121 is formed in a protruding shape that fits engaging portion 184. Engaging portion 184 and engagement portion 1214 of the present embodiment are formed in such a manner that magnet holder 121 and yoke 18 (18A to 18D) do not relatively move in the Z axis direction in an engaging state.

In yoke 18 (18A to 18D), a center recess that opens upward is formed at a center of the upper portion of yoke main body 182 of a rectangular plate shape, and yoke 18 includes stopper claws 186 that protrude in the opposing directions at upper end portions of the opposed sides of the center recess. On the other hand, in engagement portion 1214 of side wall 1211 of magnet holder 121, claw fitting parts 1212 that is depressed in the horizontal direction and is fitted to stopper claw 186 is formed on the base side of the protrusion. When stopper claw 186 is fitted to claw fitting part 1212, the relative movement of yokes 18A to 18D in the Z axis direction with respect to magnet holder 121 is restricted. With this configuration, it is possible to prevent the downward (light axis direction) positional displacement with respect to permanent magnets 122A to 122D due to the attraction of permanent magnets 122A to 122D.

Engaging portion 184 and engagement portion 1214 are engaged with each other on the outside of magnet part 122, or more specifically, on the outer surfaces (external surfaces) of permanent magnets 122A to 122D in the radial direction. With this configuration, yokes 18A to 18D, together with side wall 1211, form the side wall portion of OIS movable part 100 such that the upper part thereof is a non-magnetic substance and the lower part thereof is a magnetic substance.

Even in the case where magnet part 122 (permanent magnets 122A to 122D) held by magnet holder 121 is magnetized in advance, it is possible to attach yokes 18A to 18D to magnet holder 121 while preventing the downward positional displacement due to the attraction of magnet part 122. That is, while yokes 18A to 18D are attracted and attached to the outer surface of magnet part 122 (permanent magnets 122A to 122D), recessed engaging portion 184 is fitted to protruding engagement portion 1214 on the outer surface. With this configuration, yokes 18A to 18D are easily attracted and attached to magnet holder 121 at proper positions in the state where the relative movement in one direction of the two directions orthogonal to each other in the horizontal direction (X axis direction or Y axis direction) and the movement in the Z axis direction are restricted. Accordingly, lens driving device 1 can be easily assembled. It is to be noted that yokes 18A to 18D may be integrally molded by insert-molding together with resin magnet holder 121. Integration of the components by insert-molding can reduce the man hours and can increase positional precision at the time of assembly. In addition, magnet holder 121 may be molded with a resin containing magnetic substances.

Position detection part 16 is disposed at one of four upper spring fixing parts 121c of magnet holder 121. Position detection part 16 includes Hall device 161 that detects variation of the magnetic field by utilizing the Hall effect, and position detection substrate 162 for power feeding to Hall device 161 and extraction of the detection signal. Hall device 161 includes a detection part (not illustrated) composed of a semiconductor device, and is disposed such that the detection direction of the detection part coincides with the light axis direction. Position detection part 16 mainly detects the variation of the magnetic field of first position detection magnet 15A. With this configuration, the position of AF movable part 11 in the light axis direction is detected.

Upper elastic supporting part 13 is a leaf spring formed of beryllium copper, nickel copper, stainless-steel or the like, for example, and has a square shape as a whole in plan view. Upper elastic supporting part 13 includes upper leaf springs 131 and 132 that elastically support AF movable part 11 with respect to AF fixing part 12, power-source line parts 133 and 134 that feed power to Hall device 161, and signal line parts 135 and 136 that extract a detection signal from Hall device 161. Upper leaf springs 131 and 132, power-source line parts 133 and 134, and signal line parts 135 and 136 are shaped by etching.

Upper leaf spring 131 includes two spring parts 131A and 131B. Spring part 131A includes lens holder fixing part 131a that is fixed to lens holder 111, magnet holder fixing part 131b that is disposed at a position on the radially outside of lens holder fixing part 131a and is fixed to magnet holder 121, and arm part 131c that couples lens holder fixing part 131a and magnet holder fixing part 131b. Likewise, spring part 131B includes lens holder fixing part 131d, magnet holder fixing part 131e, and arm part 131f. Lens holder fixing parts 131a and 131d are coupled at a position on the inside of arm part 131c, and magnet holder fixing parts 131b and 131e are coupled at a position on the outside of arm parts 131c and 131f.

Lens holder fixing parts 131a and 131d have shapes corresponding to upper spring fixing parts 111e of lens holder 111. When the positioning bosses of lens holder 111 are fitted into the fixing holes of lens holder fixing parts 131a and 131d, upper leaf spring 131 is positioned and fixed to lens holder 111.

Magnet holder fixing parts 131b and 131e have shapes corresponding to upper spring fixing parts 121c of magnet holder 121. When the positioning bosses of lens holder 111 are fitted into the fixing holes of magnet holder fixing parts 131b and 131e, upper leaf spring 131 is positioned and fixed to magnet holder 121.

Arm parts 131c and 131f extend in the XY plane in a wave shape, and are elastically deformed when AF movable part 11 moves.

Upper leaf spring 131 includes wire connecting part 131g extending in a curved shape from magnet holder fixing part 131b. To wire connecting part 131g, suspension wire 33B for power feeding to AF coil part 112 (see FIG. 5) is connected. Upper leaf spring 131 includes coil connecting part 131h that has a U-shape in plan view and extends from lens holder fixing part 131d. Coil connecting part 131h is electrically connected by soldering to one end of AF coil part 112 tied to one tying part 111f of lens holder 111.

Although the shape of upper leaf spring 132 is not completely identical to that of upper leaf spring 131, their basic structures are similar to each other, and therefore, the description thereof is omitted. To wire connecting part 132g of upper leaf spring 132, suspension wire 33A for power feeding to AF coil part 112 (see FIG. 5) is connected. In addition, coil connecting part 132h is electrically connected by soldering to the other end of AF coil part 112 tied to the other tying part 111f of lens holder 111.

Power-source line part 133 includes, at the both end portions, fixing holes 133a and 133b corresponding to the positioning bosses of magnet holder 121. Power-source line part 133 includes, at one end portion, wire connecting part 133c extending in a curved shape. To wire connecting part 133c, suspension wire 32A (see FIG. 5) for power feeding to Hall device 161 is connected. The other end of power-source line part 133 is connected to the power source terminal of position detection substrate 162.

The shape of power-source line part 134 is symmetrical with power-source line part 133. To wire connecting part 134c of power-source line part 134, suspension wire 32B (see FIG. 5) for power feeding to Hall device 161 is connected. In addition, the other end of power-source line part 134 is connected to the power source terminal of position detection substrate 162.

Signal line part 135 includes fixing hole 135a corresponding to the positioning boss of magnet holder 121. Signal line part 135 includes, at one end portion, wire connecting part 135b extending in a curved shape. To wire connecting part 135b, suspension wire 31A for extraction of a detection signal from Hall device 161 (see FIG. 5) is connected. The other end of signal line part 135 is connected to the signal terminal of position detection substrate 162.

The shape of signal line part 136 is symmetrical with signal line part 135. To wire connecting part 136b of signal line part 136, suspension wire 31B (see FIG. 5) for extraction of a signal from Hall device 161 is connected. In addition, the other end of signal line part 136 is connected to the signal terminal of position detection substrate 162.

Wire connecting parts 131g, 132g, 133c, 134c, 135b and 136b are located on the light reception side in the light axis direction of wire insertion part 121a of magnet holder 121. In the state where upper elastic supporting part 13 is attached to magnet holder 121, a gap is formed between wire connecting parts 131g, 132g, 133c, 134c, 135b and 136b and damper installation part 121d (see FIG. 5). A damper is disposed in this gap. In addition, wire connecting parts 131g, 132g, 133c, 134c, 135b and 136b each have a shape which is easily elastically deformed. Deflection of wire connecting parts 131g, 132g, 133c, 134c, 135b and 136b and suspension wire 30 damps the drop impact. Accordingly, plastic deformation and rupture of suspension wire 30 due to an impact of dropping or the like can be effectively prevented.

As with upper elastic supporting part 13, lower elastic supporting part 14 is a leaf spring made of beryllium copper, nickel copper, stainless-steel or the like (hereinafter referred to as “lower leaf spring 14”), and has a square shape as a whole in plan view. Lower leaf spring 14 elastically connects AF fixing part 12 (magnet holder 121) and AF movable part 11 (lens holder 111). Lower leaf spring 14 is shaped by etching.

Lower leaf spring 14 (lower elastic supporting member) includes four spring parts 141 to 144. Spring part 141 includes lens holder fixing part 141a that is fixed to lens holder 111, magnet holder fixing part 141b that is disposed at a position at 90 degrees from lens holder fixing part 141a and is fixed to magnet holder 121, and arm part 141c that couples lens holder fixing part 141a and magnet holder fixing part 141b. The configurations of spring parts 142 to 144 are similar to the above-mentioned configuration.

In lens holder fixing parts 141a to 144a, the lens holder fixing parts adjacent to each other are coupled with coupling part 145 into a shape corresponding to a lower spring fixing part (omitted in the drawing) of lens holder 111. When the positioning bosses of the lower spring fixing part (omitted in the drawing) of lens holder 111 are fitted into the fixing holes of lens holder fixing parts 141a to 144a, lower leaf spring 14 is positioned and fixed to lens holder 111.

Magnet holder fixing parts 141b to 144b have shapes corresponding to lower spring fixing parts 121e of magnet holder 121. When the positioning bosses of lower spring fixing parts 121e are fitted into the fixing holes of magnet holder fixing parts 141b to 144b, lower leaf spring 14 is positioned and fixed to magnet holder 121.

At the time of assembling OIS movable part 100, first, position detection part 16 (Hall device 161 and position detection substrate 162) is attached to magnet holder 121, and coupling yokes 123 and 124 are attached to the yoke housing part (not illustrated) of magnet holder 121. Then, upper elastic supporting part 13 is attached to upper spring fixing part 121c.

At this time, one ends of power-source line parts 133 and 134 are soldered and electrically connected to the power source terminal of position detection substrate 162. In addition, one ends of signal line parts 135 and 136 are soldered and electrically connected to the signal terminal of position detection substrate 162.

Next, lower leaf spring 14 is attached to the lower spring fixing parts (omitted in the drawing) of lens holder 111, and in this state, lens holder 111 is fitted into magnet holder 121 from the imaging side in the light axis direction. Then, upper leaf springs 131 and 132 are attached to upper spring fixing parts 111e of lens holder 111. In addition, lower leaf spring 14 is attached to a lower spring fixing part (not illustrated) of magnet holder 121.

At this time, coil connecting part 131h of upper leaf spring 131 is soldered and electrically connected one end of AF coil part 112 tied to one tying part 111f of lens holder 111. Likewise, coil connection part 132h of upper leaf spring 132 is soldered and electrically connected to the other end of AF coil part 112 tied to the other tying part 111f of lens holder 111.

Next, permanent magnets 122A to 122D are inserted to magnet holder 121 from the imaging side in the light axis direction, and bonded thereto. At the same time, yoke part 123a of coupling yoke 123 is bonded to an end surface of permanent magnet 122A in the longitudinal direction, and yoke part 123b of coupling yoke 123 is bonded to an end surface of permanent magnet 122B in the longitudinal direction. In addition, yoke part 124a of coupling yoke 124 is bonded to an end surface of permanent magnet 122C in the longitudinal direction, and yoke part 124b of coupling yoke 124 is bonded to an end surface of permanent magnet 122D in the longitudinal direction. Next, yokes 18A to 18D are attached and fitted to magnet holder 121. To be more specific, while yokes 18A to 18D are attracted and attached to the outer surface of permanent magnets 122A to 122D by the attraction of permanent magnets 122A to 122D, engaging portion 184 is engaged with engagement portion 1214 of magnet holder 121. With this configuration, yokes 18A to 18D are positioned at respective locations on the outer surfaces of permanent magnets 122A to 122D, and engaged with magnet holder 121. Here, since stopper claw 186 is fitted to claw fitting part 1212, yokes 18A to 18D are attached to magnet holder 121 in the state where the movement in one of the X direction and the Y direction and the movement in the Z axis direction are restricted. In this manner, OIS movable part 100 (AF driving part) is assembled.

As described above, lens driving device 1 includes AF coil part 112 that is disposed at a periphery of the lens part, and AF magnet part 122 that is disposed separately from AF coil part 112 in the radial direction. Lens driving device 1 includes an AF driving part (OIS movable part 100) that performs automatic focusing by using a driving force of a voice coil motor composed of AF coil part 112 and AF magnet part 122 to move AF movable part 11 including AF coil part 112 with respect to AF fixing part 12 including AF magnet part 122 in the light axis direction.

As illustrated in FIG. 7, OIS fixing part 20 includes coil substrate 21, connection substrate 22, base member 23, position detection part 24 and the like.

In plan view, coil substrate 21 has a square shape, and has circular opening 21a at a center portion. Coil substrate 21 includes, at the four corners, wire fixing holes 21b through which the other end (lower end) of suspension wire 30 is inserted. In addition, coil substrate 21 includes positioning holes 21c at positions which intersect the diagonal direction of peripheral portions of opening 21a.

Coil substrate 21 includes OIS coil part 211 at a position opposite to magnet part 122 in the light axis direction. OIS coil part 211 includes four OIS coils 211A to 211D corresponding to permanent magnets 122A to 122D. The sizes and positions of OIS coils 211A to 211D and permanent magnets 122A to 122D are set such that the magnetic field radiated from the bottom surfaces of permanent magnets 122A to 122D traverses the long side portions of OIS coils 211A to 211D in the Z direction. The OIS voice coil motor is composed of magnet part 122 and OIS coil part 211.

As with coil substrate 21, connection substrate 22 has a square shape in plan view, and has circular opening 22a at a center portion. Connection substrate 22 includes, at peripheral portions of opening 22a , positioning holes 22b at positions corresponding to positioning holes 21c of coil substrate 21. Connection substrate 22 includes, at the two sides along the Y direction, control terminals 22c that are bent downward.

Connection substrate 22 includes, at four portions of the inner peripheral edge of opening 22a which intersect the diagonal direction, power source terminals 22d for power feeding to OIS coil part 211. In addition, connection substrate 22 includes a power-source line (not illustrated) for power feeding to AF coil part 112 and OIS coil part 211, and a signal line (not illustrated) for a detection signal output from position detection part 24. Position detection part 24 that detects the position of OIS movable part 100 in the XY plane is disposed on the rear surface of connection substrate 22.

Position detection part 24 is composed of Hall devices 24A and 24B (magnetic sensors) that detect the magnetic field by utilizing Hall effect, for example. Hall devices 24A and 24B are respectively disposed at approximate centers at adjacent two sides of the bottom surface of connection substrate 22. By detecting the magnetic field formed by magnet part 122 with Hall devices 24A and 24B, the position of OIS movable part 100 in the XY plane can be specified. It is to be noted that a magnet for position detection may be disposed independently of magnet part 122 in OIS movable part 100.

As with coil substrate 21, base member 23 has a square shape in plan view, and has circular opening 23a at a center portion. Base member 23 includes, at peripheral portions of opening 23a, positioning bosses 23b at positions corresponding to positioning holes 21c of coil substrate 21 and positioning holes 22b of connection substrate 22.

Base member 23 includes recess 23c at a position corresponding to control terminal 22c of connection substrate 22 at a peripheral portion. Recess 23c is formed in a tapered shape expanding outward toward the lower side. In addition, base member 23 includes, at peripheral portions of opening 23a, Hall device housing parts 23d that house Hall devices 24A and 24B, and terminal housing parts 23e that house power source terminals 22d of connection substrate 22.

At the time of assembling OIS fixing part 20, first, coil substrate 21 and connection substrate 22 are bonded by soldering. In this manner, the power-source line (not illustrated) of connection substrate 22 and OIS coil part 211 are electrically connected to each other.

Next, positioning holes 21c of coil substrate 21 and positioning holes 22b of connection substrate 22 are fitted to positioning bosses 23b of base member 23 to dispose coil substrate 21 and connection substrate 22 on base member 23. When control terminal 22c of connection substrate 22 is engaged with recess 23c of base member 23, coil substrate 21 and connection substrate 22 are fixed to base member 23. In this manner, OIS fixing part 20 is assembled.

As described above, lens driving device 1 includes magnet part 122 (OIS magnet part) disposed in the AF driving part, and OIS coil part 211 disposed separately from magnet part 122 in the light axis direction. Lens driving device 1 includes an OIS driving part that performs shake correction by using a driving force of a voice coil motor composed of OIS coil part 211, yoke 18 and magnet part 122 to sway OIS movable part 100 including magnet part 122 in a plane orthogonal to the light axis direction with respect to OIS fixing part 20 including OIS coil part 211.

At the time of assembling lens driving device 1, one ends of suspension wires 33A and 33B are respectively inserted to wire connecting part 132g of upper leaf spring 132 and wire connecting part 131g of upper leaf spring 131, and fixed thereto by soldering. One ends of suspension wires 32A and 32B are respectively inserted to wire connecting part 133c of power-source line part 133 and wire connecting part 134c of power-source line part 134 and fixed thereto by soldering. One ends of suspension wires 31A and 31B are respectively inserted to wire connecting part 135b of signal line part 135 and wire connecting part 136b of signal line part 136, and fixed thereto by soldering. In this manner, suspension wire 30, and upper leaf springs 131 and 132, power-source line parts 133 and 134, and signal line parts 135 and 136 are electrically connected together.

Next, the other end (lower end) of suspension wire 30 is inserted to wire fixing hole 21b of coil substrate 21, and is fixed by soldering. In this manner, the power-source line and the signal line of connection substrate 22 and suspension wire 30 are electrically connected to each other. That is, it is possible to perform power feeding to AF coil part 112 and Hall device 161 and operation control of Hall device 161 through suspension wire 30 and upper elastic supporting part 13.

In addition, a damper (not illustrated) is disposed at damper installation part 121d (including upper portion of wire insertion part 121a) of magnet holder 121 in such a manner as to surround suspension wire 30. Thus the damper is interposed between magnet holder 121 and upper leaf springs 131 and 132. By interposing the damper (not illustrated) between magnet holder 121 and upper leaf springs 131 and 132, generation of unnecessary resonance (high-order resonance mode) can be reduced, and consequently, the stability of the operation can be ensured. The damper can be readily applied to damper installation part 121d by use of a dispenser. For example, ultraviolet curing silicone gel can be adopted as the damper.

Shield cover 2 is attached to lens driving device 1 such that a lower end portion of shield cover 2 makes contact with a ground terminal (not illustrated) of connection substrate 22. Since shield cover 2 is grounded through the ground terminal (not illustrated), EMC noise cab be blocked.

At the time of shake correction in lens driving device 1, OIS coil part 211 is energized. When OIS coil part 211 is energized, a Lorentz force is generated at OIS coil part 211 by interaction between the magnetic field of magnet part 122 and the current flowing through OIS coil part 211 (Fleming's left hand rule). The direction of the Lorentz force is the direction (the Y direction or the X direction) orthogonal to the direction of the magnetic field (the Z direction) and to the direction of the current flowing through the long side portion of OIS coil part 211 (the X direction or the Y direction). Since OIS coil part 211 is fixed, a reactive force acts on magnet part 122. With this reactive force serving as the driving force of the OIS voice coil motor, OIS movable part 100 including magnet part 122 sways in the XY plane, and thus shake correction is performed.

At the time of automatic focusing in lens driving device 1, AF coil part 112 is energized. When AF coil part 112 is energized, a Lorentz force is generated at AF coil part 112 by interaction between the magnetic field of magnet part 122 and the current flowing through AF coil part 112. The direction of the Lorentz force is the direction (the Z direction) orthogonal to the direction of the magnetic field (X direction or Y direction) and the direction of the current flowing through the AF coil part 211 (the Y direction or the X direction). Since magnet part 122 is fixed, a reactive force acts on AF coil part 112. With this reactive force serving as the driving force of the AF voice coil motor, AF movable part 11 including AF coil part 112 moves in the light axis direction, and thus focusing is performed.

Here, in an non-energization state where focusing is not performed, AF movable part 11 is suspended between the infinity position and the macro position with upper leaf springs 131 and 132 and lower leaf spring 14 (hereinafter referred to as “reference state”). That is, in OIS movable part 100, AF movable part 11 (lens holder 111) is elastically supported such that AF movable part 11 is displaceable in the Z direction in the state where the position of AF movable part 11 with respect to AF fixing part 12 (magnet holder 121) is set by upper leaf springs 131 and 132, and lower leaf spring 14.

At the time of focusing, the direction of the current is controlled based on whether AF movable part 11 is moved from the reference state toward the macro position side or toward the infinity position side. In addition, the value of the current is controlled based on the movement length of AF movable part 11.

When AF movable part 11 moves to the infinity position side at the time of focusing, the bottom surface of protruding part 111d of lens 111 holder approaches the top surface of magnet part 122, and finally makes contact with the top surface of magnet part 122. That is, the movement to the infinity position side is restricted by the bottom surface of protruding part 111d of lens holder 111 and the top surface of magnet part 122. When AF movable part 11 moves to the macro position side at the time of focusing, the top surface of protruding part 111d of lens holder 111 approaches the bottom surface of stopper part 121b of magnet holder 121, and finally makes contact with the bottom surface of stopper part 121b. That is, the movement to the macro position side is restricted by the top surface of protruding part 111d of lens holder 111 and the bottom surface of stopper part 121b of magnet holder 121.

Further, in the AF driving part of lens driving device 1, a closed loop control is performed based on a detection signal of position detection part 16. With the closed loop control method, the hysteresis characteristics of the voice coil motor are not required to be considered, and the stability of the position of AF movable part 11 can be directly detected. Furthermore, automatic focusing of an image surface detection method can be adopted. Accordingly, with high responsiveness, speedup of the automatic focusing operation can be achieved.

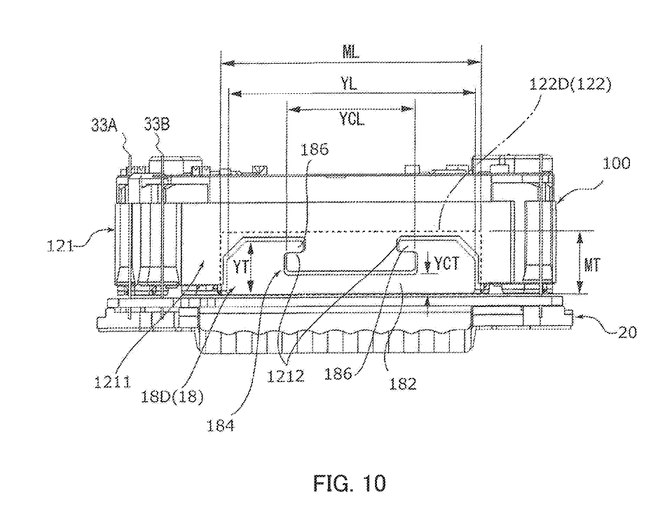

Next, a relationship between yoke 18 (18A to 18D) and magnet part 122 (permanent magnets 122A to 122D) functioning as an OIS driving part that performs shake correction in camera module A is described. FIG. 10 is a side view (right side view) of lens driving device 1, which illustrates a relationship between yoke 18 and magnet part 122.

The height, length and thickness of the shape of yokes 18A to 18D are set such the magnetic flux is not saturated in permanent magnets 122A to 122D that function as the magnetic circuit of the OIS driving part. As pairs with engaging portions 184 of recesses at a center of the upper portion of yokes 18A to 18D, engagement portions 1214 at the lower portions of the four side walls 1211 of magnet holder 121 each include, at a center of a lower portion thereof, a protrusion that is fitted to the recess of engaging portion 184. It is desirable that yokes 18A to 18D be attached to the entirety of the outer surfaces (magnetization surfaces located in the magnetization direction) of respective permanent magnets 122A to 122D in view of concentration of magnetic flux; however, since yokes 18A to 18D are formed with SPCC for example, it is also necessary to take the weight thereof into consideration. Yokes 18A to 18D are provided as a part of the AF movable part, and therefore when the weight is large, the thrust of the magnetic flux for the movement, the power consumption, and the configuration of the entire apparatus are accordingly increased.

It is known that, in a configuration in which permanent magnets 122A to 122D and yokes 18A to 18D are movably disposed on the upper side of OIS coil part 211 that functions as the OIS driving part of the present embodiment, the magnetic flux density at a portion in the vicinity of a center of the upper portion of yoke 18 is low. In view of this, in the present embodiment, the portion where the magnetic flux density is low is cut off into a recessed shape, and accordingly a downward protrusion is formed at a center of the lower portion of magnet holder 121 such that the parts fit each other. With this configuration, the weight of yokes 18A to 18D are reduced without reducing the magnetic flux density, thus achieving a shape having a high weight efficiency.

When yoke length YL is excessively long with respect to permanent magnets 122A to 122D in a configuration in which yokes 18A to 18D are attached to the magnetic pole surfaces of permanent magnets 122A to 122D, the magnetic flux easily goes around from the side surfaces of permanent magnets 122A to 122D. Consequently, the thrust for swaying OIS movable part 100 in the XY plane (the thrust for shake correction) is reduced.

In addition, when the heights of yokes 18A to 18D are excessively greater than the heights of permanent magnets 122A to 122D, the magnetic flux easily goes around from the upper side of permanent magnets 122A to 122D. Consequently, while the thrust as the AF driving part increases, the thrust for swaying OIS movable part 100 in the XY plane (the thrust for shake correction) is reduced. In addition, when the thicknesses of yokes 18A to 18D (sheet thicknesses, that is, the length in the radial direction, and the length in the direction of the X axis or the Y axis) are excessively smaller than the thicknesses of permanent magnets 122A to 122D, the magnetic flux is saturated, and the permeance is reduced, thus reducing the effect of concentration of the magnetic flux. On the other hand, when the thickness is excessively large, the efficiency of the magnetic circuit is reduced. Consequently, the thrust for swaying OIS movable part 100 in the XY plane (the thrust for shake correction) is reduced.

In view of this, desirably, yoke length YL of each of yokes 18A to 18D is shorter than magnet length ML of magnet part 122 (permanent magnets 122A to 122D), and is 90% of ML, for example. In addition, desirably, length YCL of a center of the upper portion of each of yokes 18A to 18D is 50% of yoke length YL. In addition, desirably, height YT of each of yokes 18A to 18D is smaller than magnet height MT of magnet part 122 (permanent magnets 122A to 122D), and is 70% of MT, for example. In addition, desirably, height YCT of a center portion of each of yokes 18A to 18D is smaller than magnet height MT of magnet part 122 (permanent magnets 122A to 122D), and is 30% of MT, for example. In addition, the thickness of each of yokes 18A to 18D is 0.16 to 0.2 mm, and therefore the weight of the movable part can be set to an appropriate value.

In view of the above-mentioned points, the shape (length, height, and thickness) of yoke 18 (18A to 18D) is set in accordance with the shape of magnet part 122 (permanent magnets 122A to 122D). Accordingly, yoke 18 (18A to 18D) has a shape that achieves a largest thrust of OIS driving part (shake correction) and a small weight increase of yoke 18 (18A to 18D) (a shape that achieves high weight efficiency of yoke 18 itself). Accordingly, the magnetic flux density applied to OIS coil part 211 is set to a level at which the magnetic flux is not saturated (for example, a magnetic flux density of approximately 1.5T), and thus the shake-correcting thrust can be improved.

In addition, since the permeance of permanent magnets 122A to 122D is also improved, the thrust generated by AF coil part 112 (the thrust of AF driving part) can also be improved. For example, in the case where yoke 18 and magnet part 122 are configured in the above-mentioned dimension, when the thrust of OIS coil part 211 is improved by little under 20%, the thrust of AF coil part 112 is improved by approximately 5%. A camera module including the lens driving device of the present embodiment can ensure a favorable thrust for the OIS while achieving downsizing.

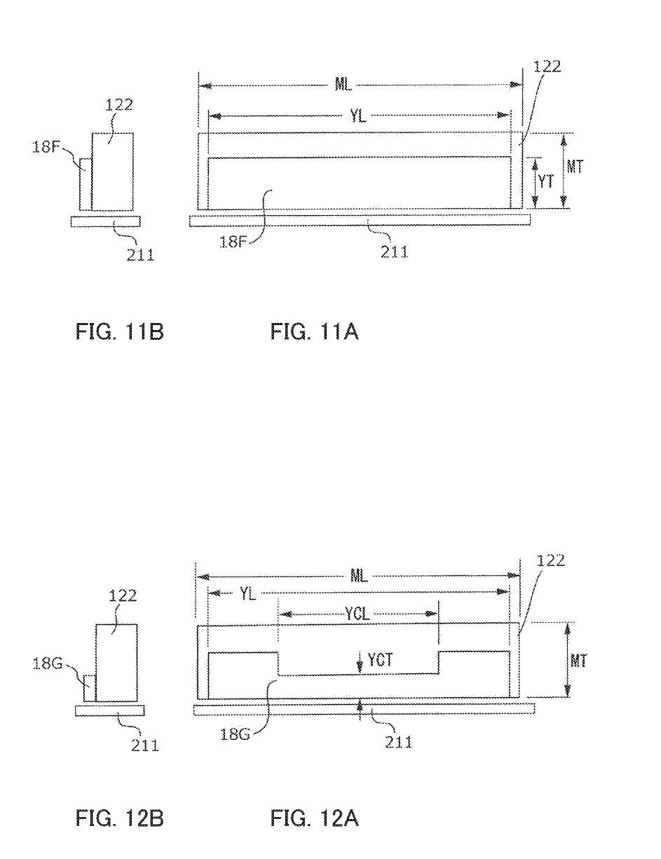

In addition, yoke 18 and magnet part 122 may be molded in shapes illustrated in FIGS. 11A to 12B. FIGS. 11A to 12B schematically illustrate a modification of the yoke. FIG. 11A and FIG. 12A are side views schematically illustrating a positional relationship between magnet part 122 (corresponding to the permanent magnets), yoke 18, and OIS coil part 211, and FIG. 11B and FIG. 12B are sectional views of a center portion of the yoke illustrated in FIG. 11A and FIG. 12A.

Yoke 18F illustrated in FIGS. 11A and 11B has a rectangular plate shape, and the engaging portion of yoke 18 has a horizontal straight-line shape. Yoke length YL of yoke 18F is shorter than magnet length ML of magnet part 122, and is 90% of ML. Height YT of yoke 18F is shorter than magnet height MT of magnet part 122, and is 70% of MT, for example. In addition, yoke 18F is entirely engaged with a recess that opens at a lower portion of the side wall of magnet holder 121 so as to form a planar side wall part. With this configuration, at the time of assembly of lens driving device 1, yoke 18F can be positioned and attached at a suitable position in the XY direction even when yoke 18F is attracted by the attraction of permanent magnets 122A to 122D.

Yoke 18G illustrated in FIGS. 12A and 12B has a recessed shape that opens at the center of the upper part. Yoke length YL of yoke 18G is shorter than magnet length ML of magnet part 122, and is 90% of ML, for example. Height YCT of a center portion of yoke 18G is shorter than magnet height MT of magnet part 122 (permanent magnets 122A to 122D), and is 30% of MT, for example. Length YCL of a center of the upper portion of the bottom side of the recess of yokes 18A to 18D is 50% of yoke length YL, for example. Height YT of yoke 18G is shorter than magnet height MT of magnet part 122 and is 70% of MT, for example. In addition, yoke 18G is engaged with the irregular portion that opens on the lower side of the side wall of magnet holder 121 at the upper portion thereof so as to form a planar side wall part.

With this configuration, at the time of assembly of lens driving device 1, yoke 18F can be positioned and attached at a suitable position in the XY direction even when yoke 18F is attracted by the attraction of permanent magnets 122A to 122D. In addition, in the magnetic circuit illustrated in FIGS. 11A and 11B, the magnetic flux density is lowest at the center of the upper portion of yoke 18 (18A to 18D). Accordingly, since the center portion of the upper part is cut out, yoke 18G illustrated in FIGS. 12A and 12B can reduce the weight of OIS movable part 100 without reducing the magnetic flux density, and can improve the thrust for OIS movable part 100. It is to be noted that engagement portion 1214 of magnet holder 121 that is engaged with engaging portion 184 of yoke 18G has a shape that can be fitted thereto in accordance with the shape of engaging portion 184 of yoke 18G.

While yoke 18 (18A to 18D) is attached to the outer surface (one surface of the magnetic pole surfaces) of magnet part 122 (permanent magnets 122A to 122D) in the present embodiment, yoke 18 (18A to 18D) may be attached to the inner surface of magnet part 122 (permanent magnets 122A to 122D), or to both the inner surface and the outer surface of magnet part 122 (permanent magnets 122A to 122D). With this configuration, the thrust for moving OIS movable part 100 can be further increased.

While the invention made by the present inventor has been specifically described based on the preferred embodiments, it is not intended to limit the present invention to the above-mentioned preferred embodiments but the present invention may be further modified within the scope and spirit of the invention defined by the appended claims.

While a smartphone serving as a camera-equipped mobile terminal is described in the embodiment as an example of a camera mounting device having camera module A, the present invention is applicable to a camera mounting device serving as an information apparatus or a transport apparatus. The camera mounting device serving as an information apparatus is an information apparatus including a camera module and a control section that processes image information obtained with the camera module, such as a camera-equipped mobile phone, a note-type personal computer, a tablet terminal, a mobile game machine, a webcamera, and a camera-equipped in-vehicle apparatus (for example, a rear-view monitor apparatus or a drive recorder apparatus). In addition, the camera mounting device serving as a transport apparatus is a transport apparatus including a camera module and a control section that processes an image obtained with the camera module, such as an automobile.

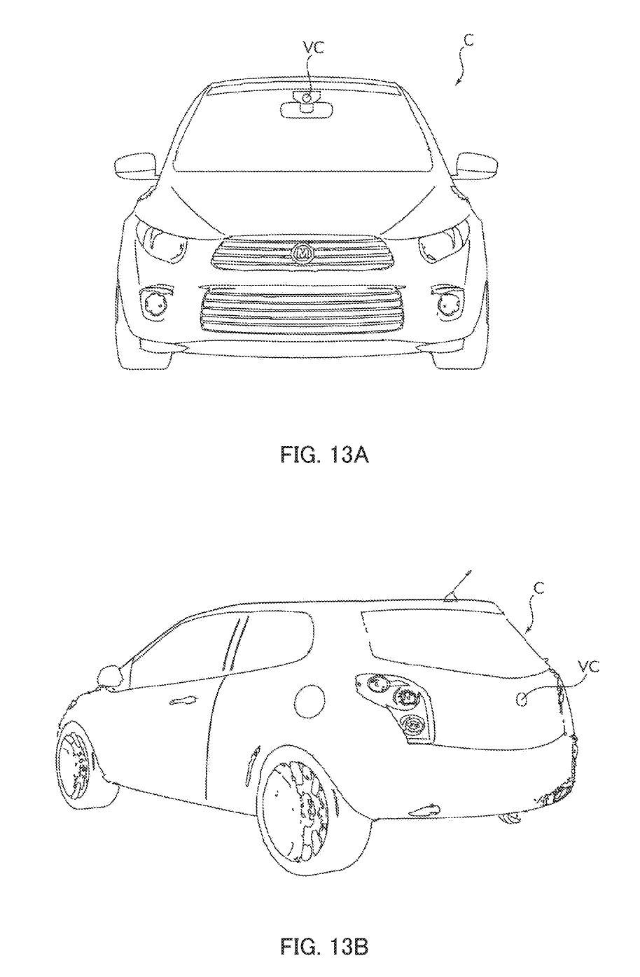

FIGS. 13A and 13B illustrate automobile C serving as a camera mounting device in which an in-vehicle camera module vehicle camera (VC) is mounted. FIG. 13A is a front view of automobile C, and FIG. 13B is a rear perspective view of automobile C. In automobile C, camera module A described in the embodiment is mounted as in-vehicle camera module VC. As illustrated in FIGS. 13A and 13B, in-vehicle camera module VC is attached to the windshield so as to face the front side, for example, or attached to the rear gate so as to face the rear side. This in-vehicle camera module VC is used for a rear-view monitor, a drive recorder, collision-avoidance control, automatic operation control, and the like.

The embodiment disclosed herein is merely an exemplification and should not be considered as limitative. The scope of the present invention is specified by the following claims, not by the above-mentioned description. It should be understood that various modifications, combinations, sub-combinations and alterations may occur depending on design requirements and other factors in so far as they are within the scope of the appended claims or the equivalents thereof.

This disclosure of Japanese Patent Application No. 2015-170921, filed on Aug. 31, 2015, including the specification, drawings and abstract, is incorporated herein by reference in its entirety.

### Reference Signs List

1 Lens driving device
2 Shield cover
18, 18A, 18B, 18C, 18D Yoke
11 AF movable part
12 AF fixing part
20 OIS fixing part
100 OIS movable part (Shake correction movable part, AF driving part)
111 Lens holder
112 AF coil part
121 Magnet holder
122 Magnet part (AF magnet part, OIS magnet part)
122A, 122B, 122C, 122D Permanent magnet
184 Engaging portion (recess)
186 Stopper claw (claw part)
211 OIS coil part
1211 Side wall
1212 Claw fitting part
1214 Engagement portion (protrusion)
M Smartphone
A Camera module

1. A lens driving device comprising a shake-correcting driving part, wherein:
the shake-correcting driving part includes
a magnet part that is disposed at a periphery of a lens part,
a magnet holder that holds the magnet part, and
a shake-correcting coil part that is disposed in such a manner that the shake-correcting coil part is separated from the magnet part in a light axis direction;
the shake-correcting driving part performs shake correction by swaying, in a plane orthogonal to the light axis direction, a shake correction movable part including the magnet part and the magnet holder with respect to a shake correction fixing part including the shake-correcting coil part by using a driving force of a voice coil motor including the magnet part and the shake-correcting coil part;
the shake correction movable part includes a yoke, the yoke being configured to be engaged with the magnet holder and disposed on a side of one surface of the magnet part, the one surface being one of surfaces of the magnet part spacing away from each other in a direction orthogonal to the light axis direction; and
a surface of the yoke on the shake-correcting coil part side is flush with a surface of the magnet part on the shake-correcting coil part side.

2. The lens driving device according to claim 1, wherein:
the shake correction movable part further includes an auto-focusing driving part, the auto-focusing driving part including an auto-focusing coil part that is disposed at a periphery of the lens part; and
the auto-focusing driving part performs automatic focusing by moving, in the light axis direction, an auto focus movable part including the auto-focusing coil part with respect to an auto focus fixing part including the magnet part by using a driving force of a voice coil motor including the auto-focusing coil part and the magnet part.

3. The lens driving device according to claim 1, wherein:
the yoke includes an engaging portion, the engaging portion being configured to be engaged with an engagement portion formed in the magnet holder, and disposed on the side of the one surface of the magnet part, the one surface being one of surfaces of the magnet part spacing away from esch other in the direction orthogonal to the light axis direction; and
when the engaging portion and the engagement portion are engaged with each other, the yoke is positioned with respect to the magnet part.

4. The lens driving device according to claim 3, wherein:
the yoke has a rectangular plate shape that is attached to the magnet part;
the engaging portion includes a recess that is formed by cutting out a center portion of an upper part of the yoke; and
the engagement portion includes a protrusion that is engaged with the recess.

5. The lens driving device according to claim 3, wherein the engaging portion and the engagement portion are provided with a claw part and a claw fitting part, the claw part and the claw fitting part being configured to fit each other to restrict a relative movement of the magnet holder and the yoke in the light axis direction.

6. The lens driving device according to claim 1, wherein:
the magnet holder is formed with a resin material;
the yoke is formed with a steel sheet that is a magnetic substance; and
the yoke is formed by insert-molding in the magnet holder.

7. A camera module comprising:
the lens driving device according to claim 1;
a lens part that is mounted to the auto focus movable part; and
an image pickup part that captures a subject image imaged by the lens part.

8. A camera mounting apparatus that is an information apparatus or a transport apparatus, the camera mounting apparatus comprising the camera module according to claim 7.
